(19) United States
(12) Patent Application Publication
(10) Pub. No.: US 2018/0165793 A1
(43) Pub. Date: Jun. 14, 2018

(54) DISPLAY APPARATUS FOR PROVIDING USER INTERFACE AND CONTROLLING METHOD THEREOF

(71) Applicant: SAMSUNG ELECTRONICS CO., LTD., Suwon-si (KR)

(72) Inventors: Eun Jung JEON, Goyang-si (KR); Hee Jin KO, Bucheon-si (KR); Jang Won SEO, Seoul (KR); Jae JULIEN, Seoul (KR)

(73) Assignee: SAMSUNG ELECTRONICS CO., LTD., Suwon-si (KR)

(21) Appl. No.: 15/840,629

(22) Filed: Dec. 13, 2017

(30) Foreign Application Priority Data
Dec. 13, 2016 (KR) 10-2016-0169906

(51) Int. Cl. G06T 3/40; G06F 3/0482

(52) U.S. Cl. CPC G06T 3/40; G06F 2203/04806; G06F 3/0482

(57) ABSTRACT

A display apparatus includes a display, an input module configured to receive a user input, and a processor configured to display a user interface (UI) to provide a plurality of objects to be selected on the display, receive the user input from the input module to select at least one of the plurality of objects from the UI displayed on the display, and change a size of the selected at least one object corresponding to the user input by enlarging the size of the selected at least one object corresponding to the user input during a first time and reduce the size of the selected at least one object corresponding to the user input during a second time, or by reducing the size of the selected at least one object corresponding to the user input during the first time and enlarge the size of the selected at least one object corresponding to the user input during the second time.

### CROSS-REFERENCE TO RELATED APPLICATION(S)

This application claims the benefit under 35 U.S.C. § 119(a) of a Korean patent application filed on Dec. 13, 2016 in the Korean Intellectual Property Office and assigned Serial number 10-2016-0169906, the entire disclosure of which is hereby incorporated by reference.

### TECHNICAL FIELD

The present disclosure relates to a display apparatus providing a user interface (UI) to change a selected object and a controlling method thereof.

### BACKGROUND

A display apparatus is providing content and a function for convenience of a user. The display apparatus may receive content to be displayed in a display or information about a function to be executed from the user through a remote control apparatus.

The display apparatus is providing various content and functions to the user while developing into the form of a smart television (TV). As such, the display apparatus may display a plurality of content and functions provided in a UI and may receive content to be displayed in the display or information about a function to be executed from the user through the UI.

To display various content and functions to be provided to the user in a limited display, the display apparatus may divide menus to be displayed in the UI into a plurality of layers, and when a menu is selected, may display content and a function corresponding to the selected menu in the UI.

### SUMMARY

The display apparatus may display content and a function to be provided to the user in the UI by using a plurality of objects. If the user selects one of the plurality of objects, the display apparatus may display content corresponding to the selected object in the display or may execute a function corresponding to the selected object.

If receiving a user input for selecting one of the plurality of objects, the display apparatus may need to display an object corresponding to the user input in the UI. In other words, the display apparatus may need to display the selected object so as to be distinguished from unselected objects.

In addition, if the display apparatus displays the selected object in the UI so as to be statically distinguished simply from the unselected objects, it may be difficult for the user to perceive the selected object after a given time elapses, and only limited information may be provided to the user.

Aspects of the present disclosure are to address at least the above-mentioned problems and/or disadvantages and to provide at least the advantages described below. Accordingly, an aspect of the present disclosure is to provide a display apparatus capable of providing information about a selected object to a user by changing the size of the selected object and a controlling method thereof.

In accordance with an aspect of the present disclosure, a display apparatus includes a display, an input module configured to receive a user input, and a processor configured to display a user interface (UI) to provide a plurality of objects to be selected on the display, receive the user input from the input module to select at least one of the plurality of objects from the UI displayed on the display, and change a size of the selected at least one object corresponding to the user input by enlarging the size of the selected at least one object corresponding to the user input during a first time and reduce the size of the selected at least one object corresponding to the user input during a second time, or by reducing the size of the selected at least one object corresponding to the user input during the first time and enlarge the size of the selected at least one object corresponding to the user input during the second time.

In accordance with an aspect of the present disclosure, a controlling method includes displaying a UI to provide a plurality of objects to be selected on a display, receiving a user input to select at least one of the plurality of objects, and changing a size of the selected at least one object corresponding to the user input. The changing of the size of the selected at least one object includes enlarging the size of the selected at least one object corresponding to the user input during a first time and reducing the size of the selected at least one object corresponding to the user input during a second time, or reducing the size of the selected at least one object corresponding to the user input during the first time and enlarging the size of the selected t least one object corresponding to the user input during the second time.

Other aspects, advantages, and salient features of the disclosure will become apparent to those skilled in the art from the following detailed description, which, taken in conjunction with the annexed drawings, discloses various embodiments of the present disclosure.

A display apparatus providing a user interface (UI) and a controlling method of the display apparatus, according to the present disclosure, may change the size of an object corresponding to a user input, thus securing visibility associated with a selected object, reminding a user of the selected object, and indicating additional information about the selected object. Also, the display apparatus and the controlling method thereof may change a speed at which the size of the object corresponding to the user input is changed, thus providing a smooth change state to the user.

Besides, a variety of effects directly or indirectly understood through this disclosure may be provided.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a display system, according to various embodiments of the present disclosure;

FIG. 2 is a block diagram illustrating a configuration of a display apparatus, according to various embodiments of the present invention;

FIGS. 3A and 3B are views illustrating how an object of a user interface (UI) of a display apparatus according to an embodiment of the present disclosure is selected;

FIGS. 4A to 4E are views illustrating how a selected object of the display apparatus according to an embodiment of the present disclosure is scaled;

FIGS. 5A and 5B are graphs illustrating a speed at which a selected object of the display apparatus according to an embodiment of the present disclosure is scaled;

FIGS. 6A to 6C are views illustrating how an object of the UI of the display apparatus according to an embodiment of the present disclosure is selected;

FIGS. 7A to 7F are views illustrating how an object is scaled when a sub object of the display apparatus according to an embodiment of the present disclosure is changed; and

FIG. 8 is a flowchart illustrating a controlling method of the display apparatus, according to various embodiments of the present disclosure.

Throughout the drawings, it should be noted that like reference numbers are used to depict the same or similar elements, features, and structures.

### DETAILED DESCRIPTION

Hereinafter, various embodiments of this disclosure will be described with reference to accompanying drawings. Accordingly, those skilled in the art will recognize that modification, equivalent, and/or alternative on the various embodiments described herein can be variously made without departing from the scope and spirit of this disclosure. With regard to description of drawings, similar elements may be marked by similar reference numerals.

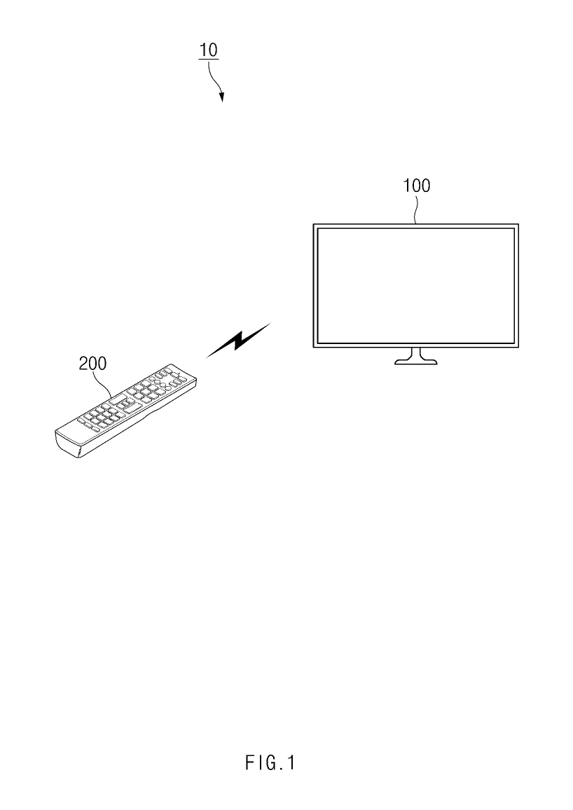

FIG. 1 is a view illustrating a display system, according to various embodiments of the present disclosure.

Referring to FIG. 1, a display system 10 may include a display apparatus 100 and a remote control apparatus 200.

The display apparatus 100 may display an image in a display. For example, the display apparatus 100 may display an image (e.g., a video image) stored in a memory of the display apparatus 100, in the display. For another example, the display apparatus 100 may be connected with a source apparatus through a wired communication interface (e.g., a high definition multimedia interface (HDMI), digital video/visual interactive (DVI), video graphics array (VGA), or the like) or a wireless communication interface (e.g., Bluetooth, near field communication (NFC), wireless-fidelity (Wi-Fi), or the like) to receive content including an image and may display the received image in the display.

According to an embodiment, the display apparatus 100 may be implemented with various apparatuses, which are able to display an image, such as a TV, a desktop, a notebook PC, a smailphone, a tablet PC, a monitor, an electronic frame, and the like.

According to an embodiment, the display apparatus 100 may display a user interface (UI) including a plurality of objects (e.g., an icon and an item) selectable by a user, in the display. According to an embodiment, the display apparatus 100 may receive a user input to select one of the plurality of objects. The display apparatus 100 may change (or scale) the size of the selected object for the purpose of displaying the selected object so as to be distinguished from the remaining unselected object(s).

The remote control apparatus 200 may transmit the user input (e.g., a control signal corresponding to the user input) to the display apparatus 100. The remote control apparatus 200 may communicate with the display apparatus 100 through a short range wireless communication interface such as a Bluetooth, NFC, an infrared (IR) transceiver, or the like. According to an embodiment, the remote control apparatus 200 may include at least one button, a touch panel, a motion recognition sensor, or a speech recognition sensor, which is used for the user to input a command.

According to an embodiment, the remote control apparatus 200 may transmit the user input to select an object of a UI displayed in the display apparatus 100 to the display apparatus 100. The user may input a command to select an object of the UI displayed in the display apparatus 100 through the remote control apparatus 200. As such, the display apparatus 100 may display an object corresponding to the received user input in the display.

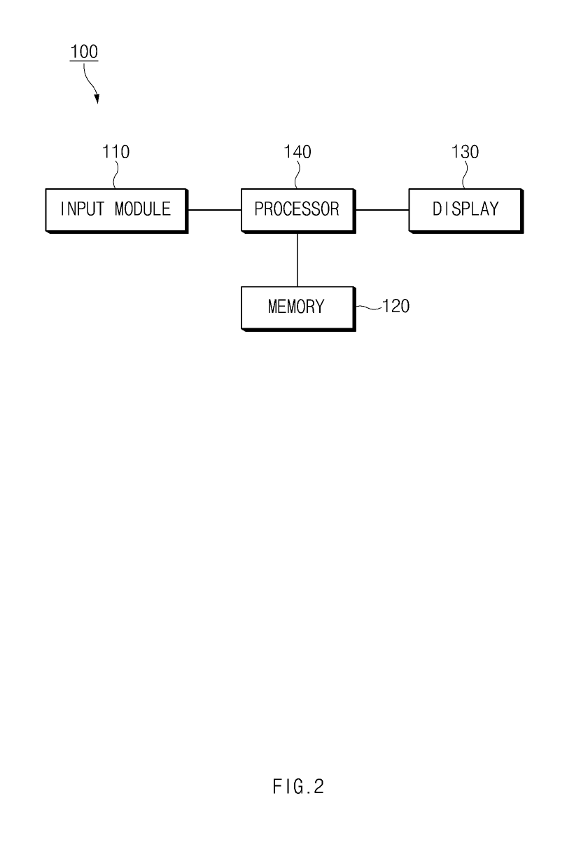

FIG. 2 is a block diagram illustrating a configuration of a display apparatus, according to various embodiments of the present disclosure.

Referring to FIG. 2, the electronic device 100 may include an input module 110, a memory 120, a display 130, and a processor 140.

The input module 110 may receive a user input for controlling the display apparatus 100. For example, the input module 110 may include a communication module (e.g., a wireless communication module or a wired communication module) and may receive the user input from an input device such as the remote control apparatus 200, a keyboard, a mouse, or the like through the communication module. For another example, the input module 110 may include an input apparatus (e.g., a button or the like) directly installed in the display apparatus 100 and may receive the user input through the input apparatus. According to an embodiment, the input module 110 may transmit the received user input to the processor 140.

The memory 120 may store content image information to be displayed in the display 130. A content image included in the content image information stored in the memory 120 may be displayed in the display 130 so as to be provided to a user.

According to an embodiment, the memory 120 may store a UI including a plurality of objects. For example, the memory 120 may store a UI including a plurality of objects each of which is implemented with at least one of a text, an image, and an icon (or an item).

The display 130 may display a content image. For example, the display 130 may display the content image stored in the memory 120. For another example, the display 130 may display an image received from a source apparatus. According to an embodiment, the display 130 may display a UI (or a UI image). The display 130 may display the content image and the UI at the same time.

The processor 140 may control overall operations of the display apparatus 100. For example, the processor 140 may receive a user input from the input module 110. The processor 140 may display a content image and a UI in the display 130 by using information stored in the memory 120.

According to an embodiment, the processor 140 may receive a user input to display a UI for selecting at least one of a plurality objects from the ui displayed on the display 130. For example, the processor 140 may receive the user input and may select at least one of a plurality objects corresponding to the user input among the plurality objects. The processor 140 may display the selected object in the display so as to be distinguished from the remaining unselected object(s).

According to an embodiment, the processor 140 may change (or scale) the size of the selected at least one object. For example, the processor 140 may reduce and enlarge the size of the selected object or may enlarge and reduce the selected object. According to an embodiment, the display apparatus 100 may change the size of the selected object at a specified period.

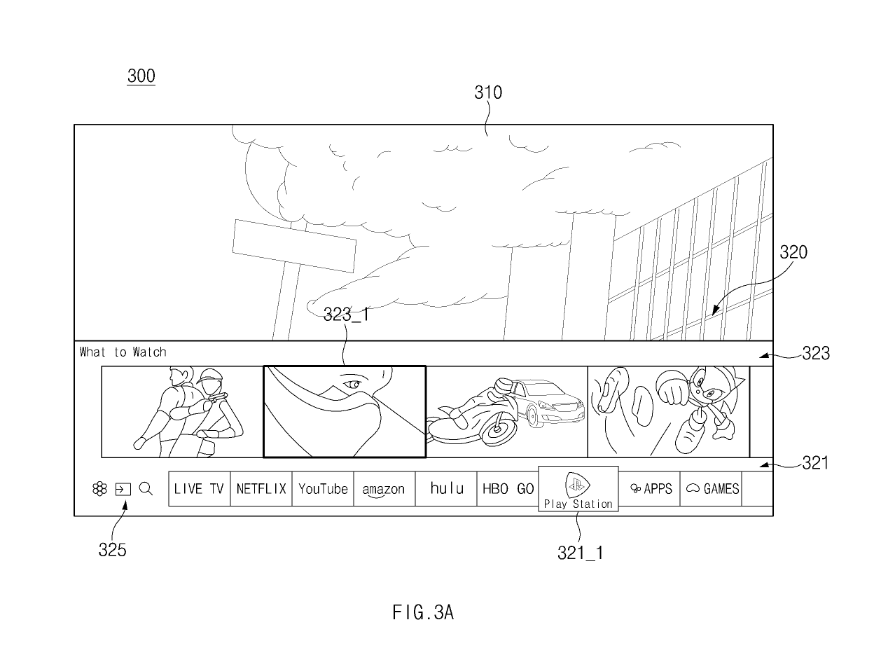

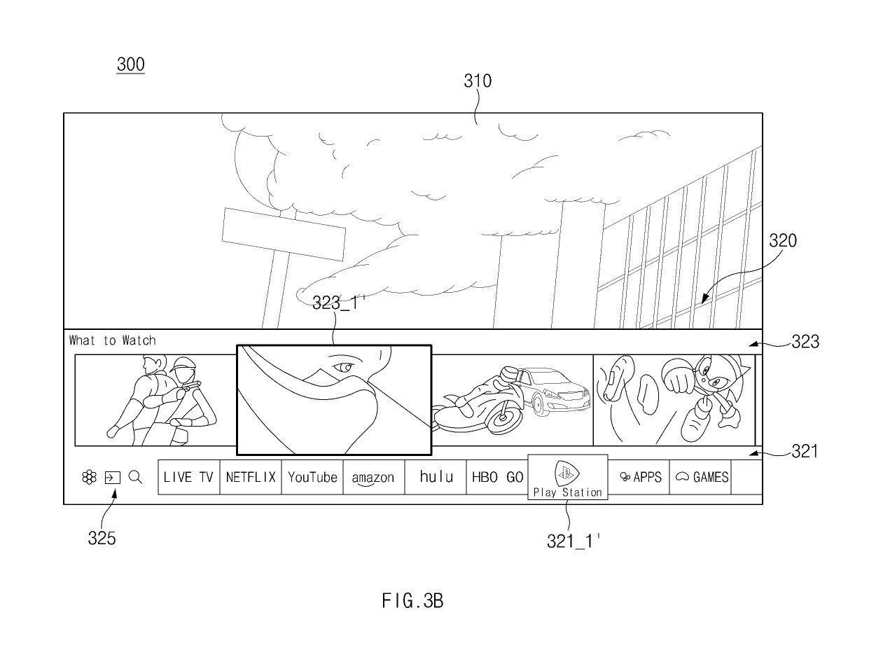

FIGS. 3A and 3B are views illustrating how an object of a user interface (UI) of a display apparatus according to an embodiment of the present disclosure is selected.

Referring to FIG. 3A, the display apparatus 100 may display at least one of a content image 310 and a UI 320 in the display 130. In other words, a screen 300 displayed in the display 130 may include at least one of the content image 310 and the UI 320. For example, the display apparatus 100 may display the content image 310 and the UI 320 in the display 130 at the same time.

The display apparatus 100 may display the UI 320 including a plurality of objects in the display 130. The UI 320 may include, for example, a first menu 321, a second menu 323, and a third menu 325.

According to an embodiment, the display apparatus 100 may display, in the UI 320, the first menu 321 for selecting the content image and the second menu 323. The first menu 321 may include, for example, at least one service object 321_1 indicating a service to be provided to a user. The second menu 323 may include at least one content object 323_1 that corresponds to an object selected in the first menu 321 and indicates a content image to be provided to the user. According to an embodiment, the display apparatus 100 may display the content image 310 corresponding to an object selected in the second menu 323 in the display 130.

According to an embodiment, the display apparatus 100 may display the third menu 325 indicating a function of the display apparatus 100 in the UI 320. The third menu 325 may include, for example, at least one function object indicating a function of the display apparatus 100.

Referring to FIG. 3B, the display apparatus 100 may receive a user input to select at least one of a plurality of objects. If receiving the user input, the display apparatus 100 may change an object corresponding to the user input.

According to an embodiment, the display apparatus 100 may select one object in the first menu 321 depending on the received user input. The display apparatus 100 may change the selected object 321_1′. For example, the display apparatus 100 may enlarge the size of the selected object 321_1′. According to an embodiment, the display apparatus 100 may display, in the UI 320, the second menu 323 corresponding to the object 321_1′ selected in the first menu 321.

According to an embodiment, the display apparatus 100 may receive a user input (e.g., a user input using a direction key) to select one object in the second menu 323. If receiving the user input, the display apparatus 100 may change an object 323_1′ of the second menu 323, which corresponds to the user input. For example, the display apparatus 100 may enlarge the size of the object 323_1′ corresponding to the user input.

According to an embodiment, if receiving a user input to display the content image 310 corresponding to a selected object in the display 130, the display apparatus 100 may display the content image 310 in the display 130.

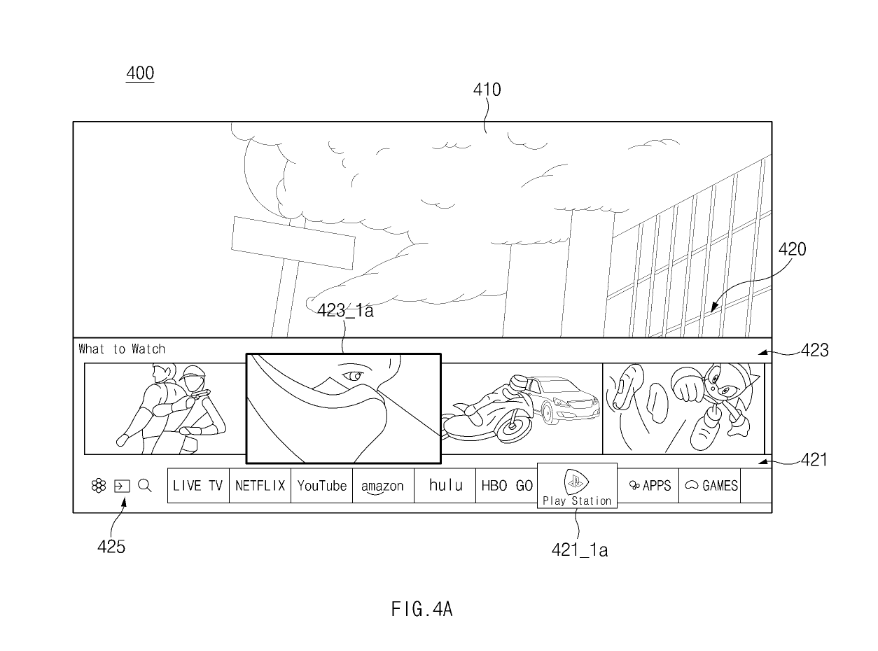

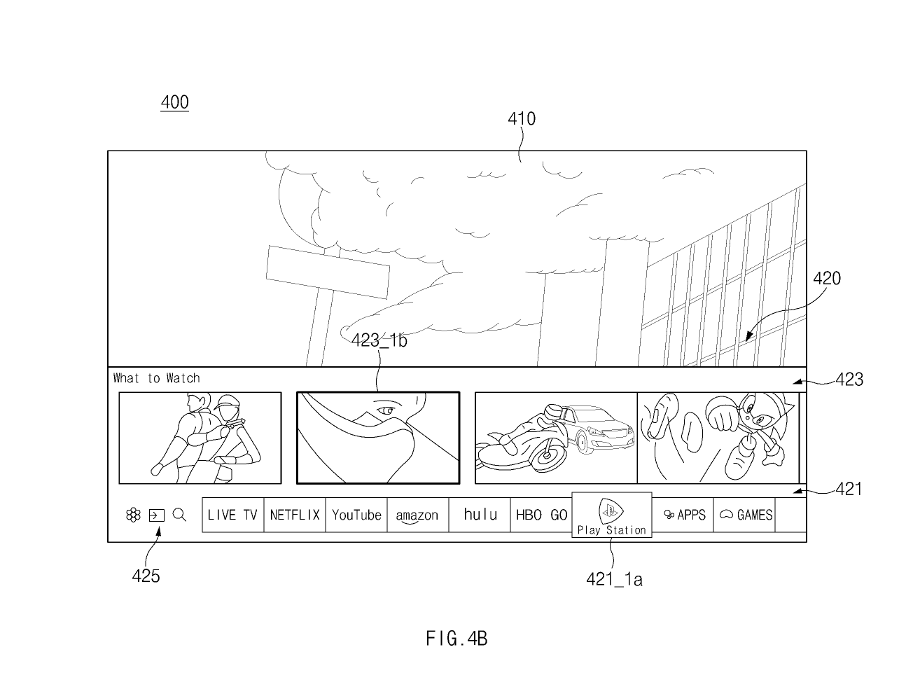

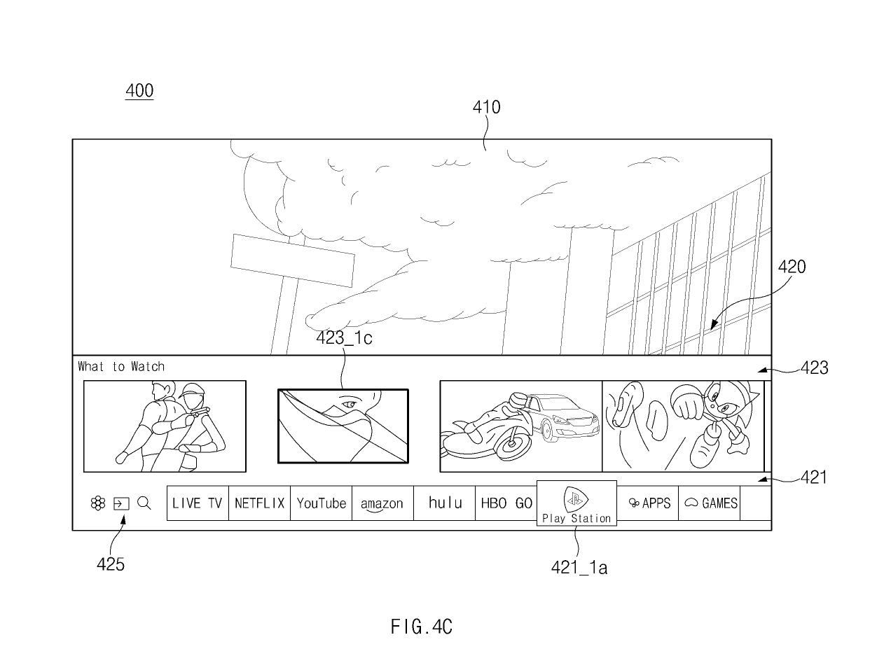

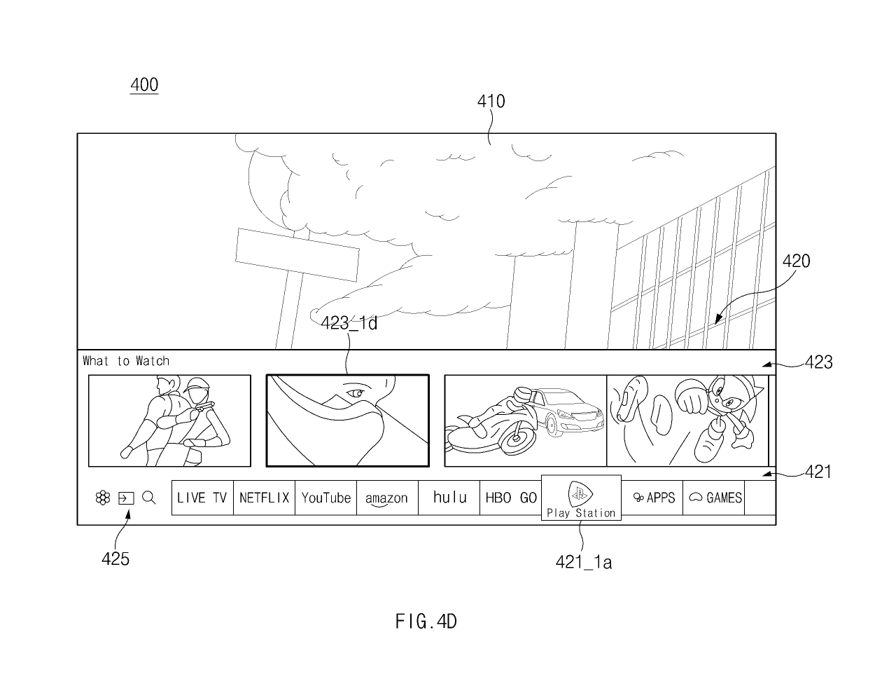

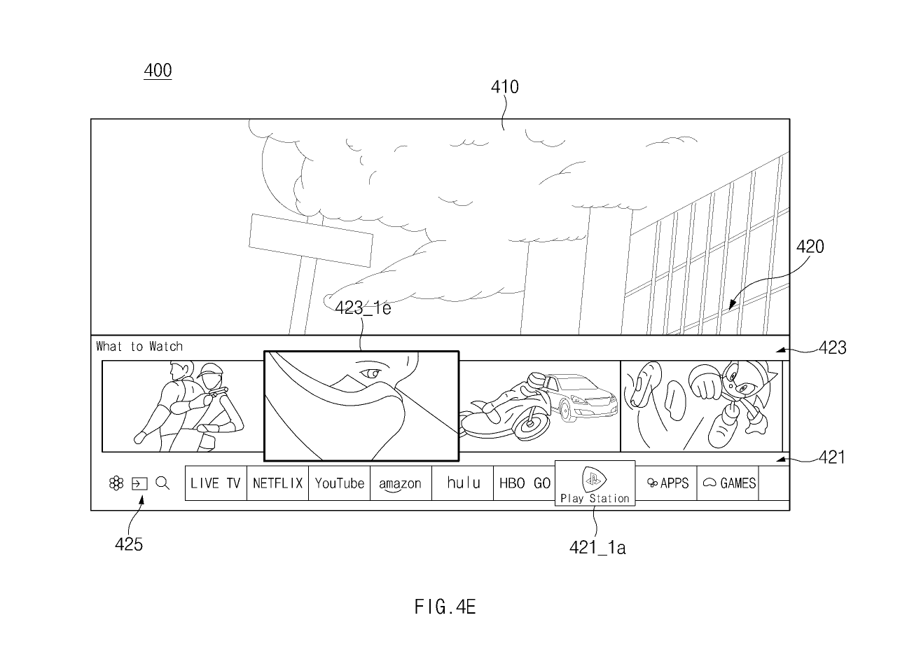

FIGS. 4A to 4E are views illustrating how a selected object of a display apparatus according to an embodiment of the present disclosure is scaled.

Referring to FIGS. 4A to 4E, the display apparatus 100 may display a content image 410 and a UI 420 in the display 130. In other words, a screen 400 displayed in the display 130 may include the content image 410 and the UI 420. When a specific time elapses after receiving a user input to select at least one of a plurality of objects, the display apparatus 100 may change an object corresponding to the user input. In other words, when a specific time elapses after selecting the object corresponding to the user input and changing the object (e.g., enlarging the size of the object), the display apparatus 100 may again change the object corresponding to the user input.

According to an embodiment, in the case where no additional user input exists after receiving a user input to select one of a plurality of objects, the display apparatus 100 may change an object corresponding to the received user input when a specific time elapses. For example, in the case where an input to display an image corresponding to the selected object does not exist during the specified time after receiving the user input, the display apparatus 100 may change the size of an object corresponding to the user input.

According to an embodiment, the display apparatus 100 may scale the size of the object corresponding to the user input. For example, the display apparatus 100 may display a second menu 423 corresponding to an object 421_1a selected in a first menu 421 in the UI 420 and may scale the size of an object of the second menu 423, which corresponds to the user input.

According to an embodiment, the display apparatus 100 may reduce (or breath out) the size of an object corresponding to a user input during a first time period T1 and may enlarge (or breath in) the reduced size of the object during a second time period T2. Alternatively, the display apparatus 100 may enlarge the size of the object corresponding to the user input during the first time period T1 and may reduce the enlarged size of the object during the second time period T2.

Referring to FIGS. 4A to 4C, the display apparatus 100 may gradually reduce the size of the object corresponding to the user input during the first time period T1. For example, the display apparatus 100 may gradually reduce the size of the object corresponding to the user input from a first state 423_1a in which the object is selected and enlarged to a second state 423_1b in which the object is selected but is not enlarged. For example, the display apparatus 100 may gradually reduce the size of the object corresponding to the user input from the second state 423_1b to a third state 423_1c in which the selected object is reduced to be smaller than any other unselected object.

Referring to FIGS. 4C to 4E, the display apparatus 100 may gradually enlarge the size of the object corresponding to the user input during the second time period T2. For example, the display apparatus 100 may gradually enlarge the size of the object corresponding to the user input from the third state 423_1c to a fourth state 423_1d in which the object is selected but is not enlarged. In addition, the display apparatus 100 may gradually enlarge the size of the object corresponding to the user input from the fourth state 423_1d to a state 423_1e in which the object is selected and enlarged.

According to an embodiment, the display apparatus 100 may change at least one of transparency, a display period, and a color of an object corresponding to the user input during the first time period T1 and the second time period T2.

According to an embodiment, the display apparatus 100 may periodically change the size of an object corresponding to a user input by using the first time period T1 and the second time period T2 as one period. For example, the display apparatus 100 may periodically enlarge and reduce (or breath) the object corresponding to the user input.

Accordingly, the display apparatus 100 may secure visibility of a user associated with an object corresponding to a user input by changing the size of the object. Also, if a specific time elapses after receiving the user input, the display apparatus 100 may change the size of the object corresponding to the user input, thus reminding the user of the selected object (or indicating the selected object to the user).

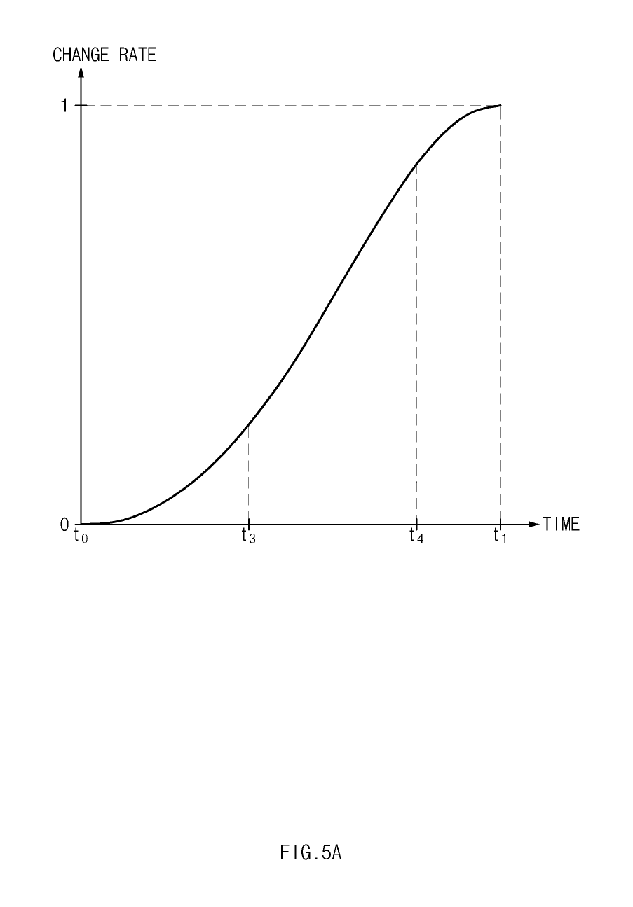

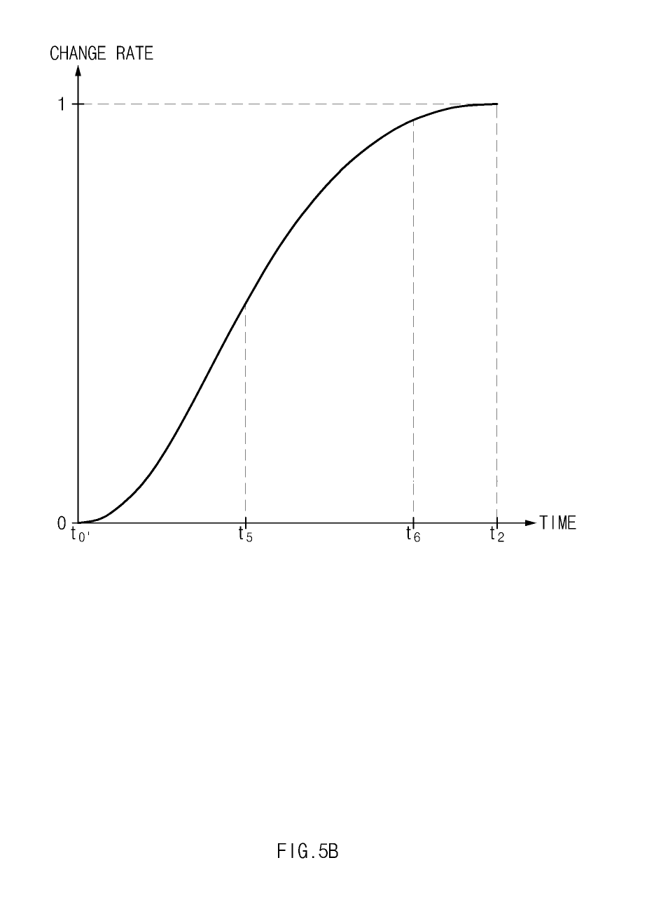

FIGS. 5A and 5B are graphs illustrating a speed at which a selected object of a display apparatus according to an embodiment of the present disclosure is scaled.

Referring to FIGS. 5A and 5B, the display apparatus 100 may change a speed at which the size of an object corresponding to a user input is changed and may change the size of the object corresponding to the user input depending on the changed speed.

Referring to FIG. 5A, the display apparatus 100 may change a speed to scale the object corresponding to the user input during the first time period T1 and may change the size of the object corresponding to the user input depending on the changed scaling speed. For example, the display apparatus 100 may increase and decrease a speed at which the object is changed during the first time period T1 and may reduce (or enlarge) the size of the object corresponding to the user input depending on the changed speed. The first time period T1 may be a time period from a start time t0 to a first time t1.

The display apparatus 100 may increase a speed (or a scaling speed) at which the size of the object corresponding to the user input is changed, from a time (or a start time) t0 to start to change the size of the object corresponding to the user input to a third time t3. For example, the display apparatus 100 may increase the scaling speed at which the size of the object corresponding to the user input is reduced, from the start time t0 to the third time t3.

According to an embodiment, the display apparatus 100 may decrease the scaling speed of the object corresponding to the user input from the fourth time t4 to the first time t1. For example, the display apparatus 100 may decrease the scaling speed at which the size of the object corresponding to the user input is reduced, from the fourth time t4 to the first time t1.

According to an embodiment, the display apparatus 100 may control the scaling speed of the object corresponding to the user input such that the scaling speed is continuously changed from the third time t3 to the fourth time t4. For example, the display apparatus 100 may maintain the scaling speed of the object corresponding to the user input at a specified speed from the third time t3 to the fourth time t4.

Referring to FIG. 5B, the display apparatus 100 may change the scaling speed of the object corresponding to the user input during the second time period T2 and may change the size of the object corresponding to the user input depending on the changed scaling speed. For example, the display apparatus 100 may increase and decrease a speed, at which the size of the object is changed, during the second time period T2 and may reduce (or enlarge) the size of the object corresponding to the user input depending on the changed speed. The second time period T2 may be a time period from a start time t0′ to a second time t2.

The display apparatus 100 may increase a speed (or a scaling speed) at which the size of the object corresponding to the user input is changed, from a time (or a start time) t0′ to start to change the size of the object corresponding to the user input to a fifth time t5. For example, the display apparatus 100 may increase the scaling speed at which the object corresponding to the user input is enlarged, from the start time t0′ to the fifth time t5.

According to an embodiment, the display apparatus 100 may decrease the scaling speed of the object corresponding to the user input from a sixth time t6 to the second time t2. For example, the display apparatus 100 may decrease the scaling speed at which the object corresponding to the user input is enlarged, from the sixth time t6 to the second time t2.

According to an embodiment, the display apparatus 100 may control the scaling speed of the object corresponding to the user input such that the scaling speed is continuously changed from the fifth time t5 to the sixth time t6. For example, the display apparatus 100 may maintain the scaling speed of the object corresponding to the user input at a specified speed from the fifth time t5 to the sixth time t6.

According to an embodiment, the display apparatus 100 may change a speed, at which the size of the object corresponding to the user input is changed, during the first time period T1 and the second time period T2 and may change the size of the selected object depending on the changed speed. For example, the display apparatus 100 may reduce the size of the object corresponding to the user input depending on the changed speed during the first time period T1 and may enlarge the size of the object corresponding to the user input depending on the changed speed during the second time period T2.

According to an embodiment, during the first time period T1, a rate (or a first rate) at which the scaling speed increases per unit time (e.g., 1 second) within a time (or a time from the start time t0 to the third time t3) when a speed at which the size of the selected object is changed increases may be set to be smaller than a rate (or a second rate) at which the scaling speed decreases per unit time within a time (or a time from the fourth time t4 to the first time t1) when a speed at which the size of the selected object is changed decreases.

According to an embodiment, during the second time period T2, the display apparatus 100 may control a rate (or a third rate) at which the scaling speed increases per unit time (e.g., 1 second) within a time (or a time from the start time t0′ to the fifth time t5) when a speed at which the size of the selected object is changed increases, so as to be greater than a rate (or a fourth rate) at which the scaling speed decreases per unit time within a time (or a time from the sixth time t6 to the second time t2) when a speed at which the size of the selected object is changed decreases.

In other words, when reducing and enlarging the size of the object corresponding to the user input during the first time period T1 and the second time period T2, the display apparatus 100 may set a rate, at which a speed at which the size of the object is changed decreases or increases per unit time, relatively small at a start time (or a time from the start time t0 to the third time t3) and an end time (or a time from the sixth time t6 to the second time t2).

According to an embodiment, the display apparatus 100 may change a speed at which the size of the object corresponding to the user input is changed, by setting the first time period T1 and the second time period T2 differently from each other. The first time period T1 may be, for example, earlier than the second time period T2, or the first time period T1 may be later than the second time period T2.

As such, the display apparatus 100 may change the scaling speed of the selected object, thus smoothly changing the size of the object corresponding to the user input. If the size of the object corresponding to the user input is smoothly changed, visibility of the user may be improved. Also, in the case where an additional input of the user exists, it may be possible to indicate a possible situation (e.g., a situation where an image corresponding to the selected object is displayed in the display 130) to the user.

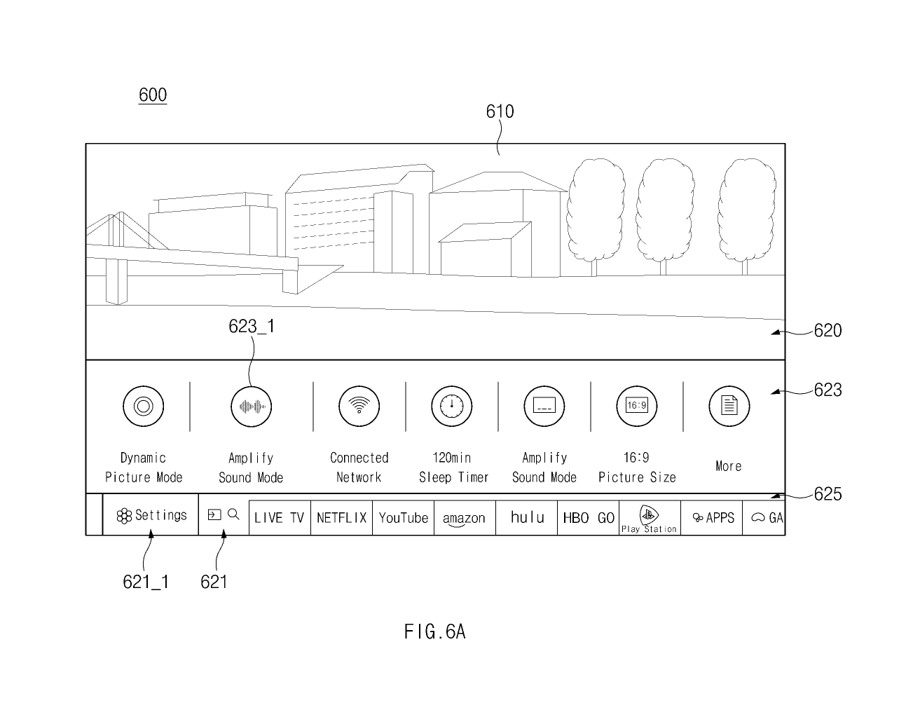

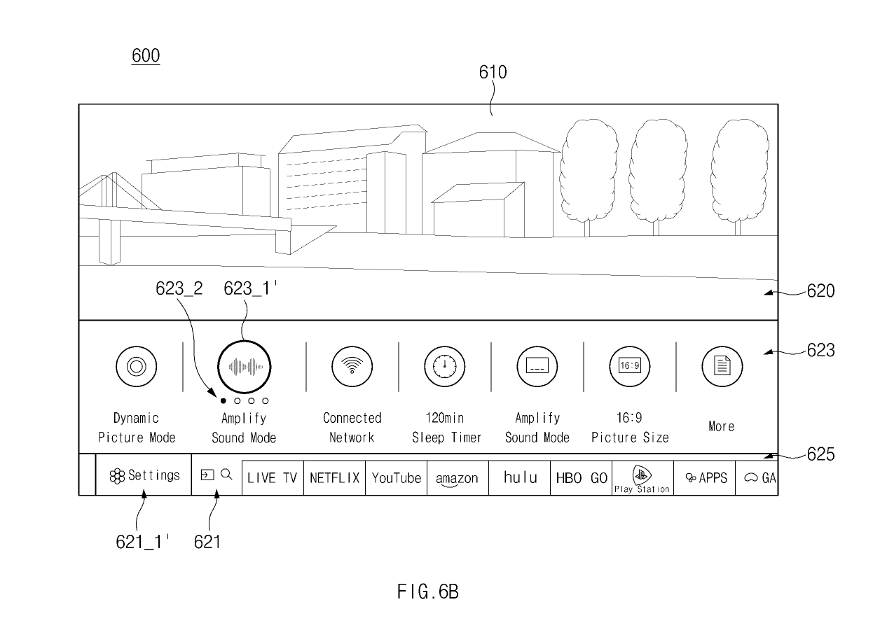

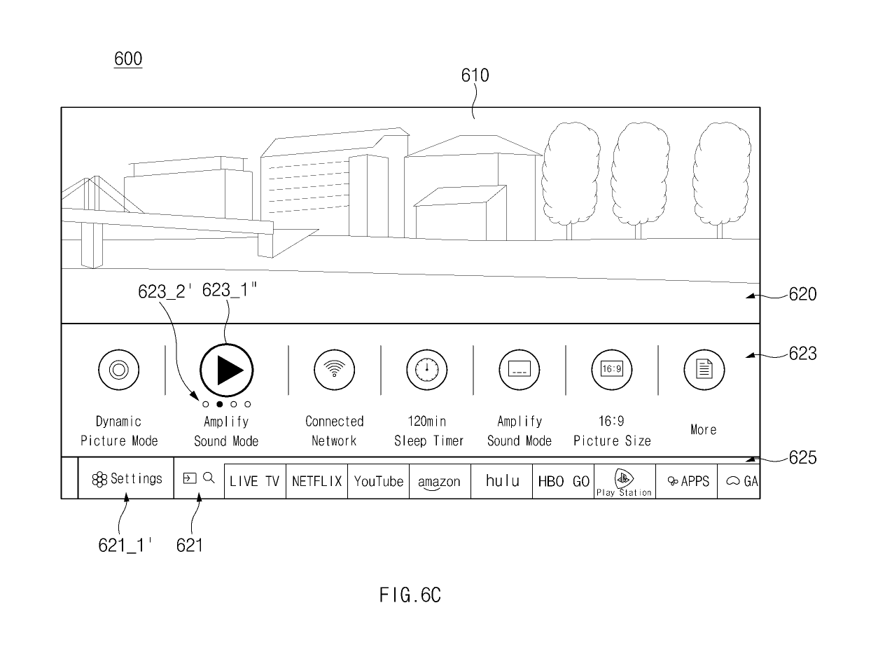

FIGS. 6A to 6C are views illustrating how an object of a UI of a display apparatus according to an embodiment of the present disclosure is selected.

Referring to FIG. 6A, the display apparatus 100 may display at least one of a content image 610 and a UI 620 in the display 130. In other words, a screen 600 displayed in the display 130 may include at least one of the content image 610 and the UI 620. For example, the display apparatus 100 may display the content image 610 and the UI 620 for setting the display apparatus 100 in the display 130 at the same time.

The display apparatus 100 may display the UI 620 including a plurality of objects in the display 130. The UI 620 may include, for example, a first menu 621, a second menu 623, and a third menu 625.

According to an embodiment, the display apparatus 100 may display, in the UI 620, the first menu 621 for selecting the content image and the second menu 623. The first menu 621 may include, for example, at least one function object 621_1 indicating a function of the display apparatus 100. The second menu 623 may include at least one content object 623_1 that corresponds to an object selected in the first menu 621 and indicates a setting state of the display apparatus 100. According to an embodiment, the display apparatus 100 may change the setting state of the display apparatus 100 corresponding to an object selected in the second menu 623. The second menu 623 may include, for example, a plurality of sub objects. The plurality of sub objects may indicate a plurality of selectable setting states, respectively.

According to an embodiment, the display apparatus 100 may include the third menu 625 for selecting a content image 610 to be displayed in the display 130. The third menu 625 may include, for example, at least one service object indicating a service to be provided to a user.

Referring to FIGS. 6B and 6C, the display apparatus 100 may receive a user input to select at least one of a plurality of objects. If receiving the user input, the display apparatus 100 may change an object corresponding to the user input.

According to an embodiment, the display apparatus 100 may select one object in the first menu 621 depending on the received user input. The display apparatus 100 may change the selected object 621_1′. For example, the display apparatus 100 may enlarge the size of the selected object 621_1′. According to an embodiment, the display apparatus 100 may display, in the UI 620, the second menu 623 corresponding to the object 621_1′ selected in the first menu 621.

Referring to FIG. 6B, the display apparatus 100 may receive a user input (e.g., a user input using a direction key) to select one object in the second menu 623. If receiving the user input, the display apparatus 100 may change an object 623_1′ of the second menu 623, which corresponds to the user input. For example, the display apparatus 100 may enlarge the size of the object 623_1′ corresponding to the user input. According to an embodiment, the display apparatus 100 may display an indicator 623_2 corresponding to a sub object (or a sub object before changed) of the selected object in the display 130. Also, the display apparatus 100 may display an image corresponding to a sub object of the selected object in the object 623_1′ in which the sub object is included.

Referring to FIG. 6C, in a state where one object in the second menu 623 is selected, the display apparatus 100 may receive a user input (e.g., a user input using a direction key) to select one sub object of a plurality of sub objects included in the selected object. If receiving the user input, the display apparatus 100 may change an object 623_1″ of the second menu 623, in which the plurality of sub objects are included. For example, the display apparatus 100 may enlarge the size of the selected object 623_1″ in which the plurality of sub objects are included. According to an embodiment, the display apparatus 100 may display an indicator 623_2′ corresponding to the selected sub object (or a sub object to be changed) in the display 130. Also, the display apparatus 100 may change an image of the object 623_1″, in which the plurality of sub objects are included, to an image corresponding to the selected sub object.

As such, if receiving a user input for changing to a setting value corresponding to a selected sub object, the display apparatus 100 may change a setting state of the display apparatus 100 to the setting value.

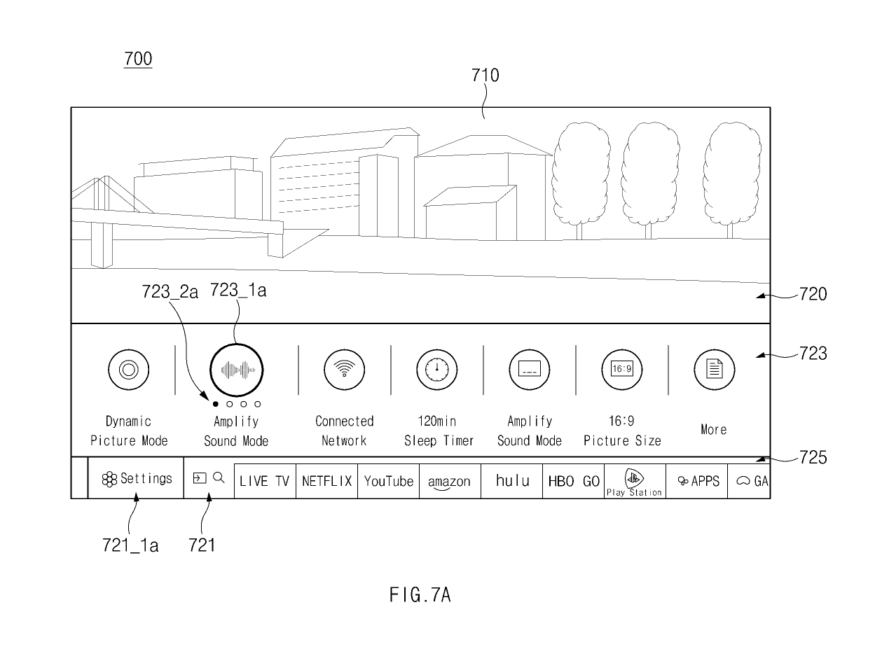

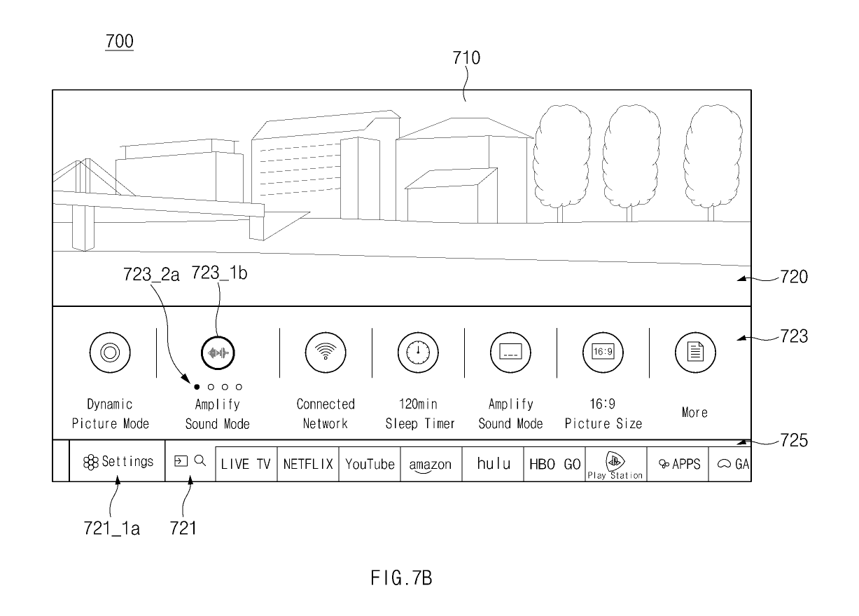

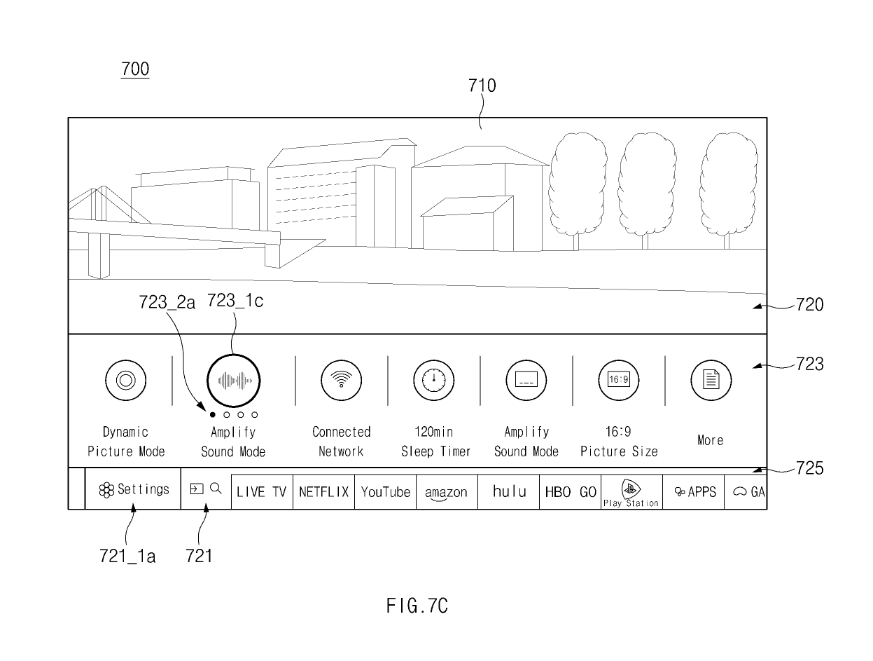

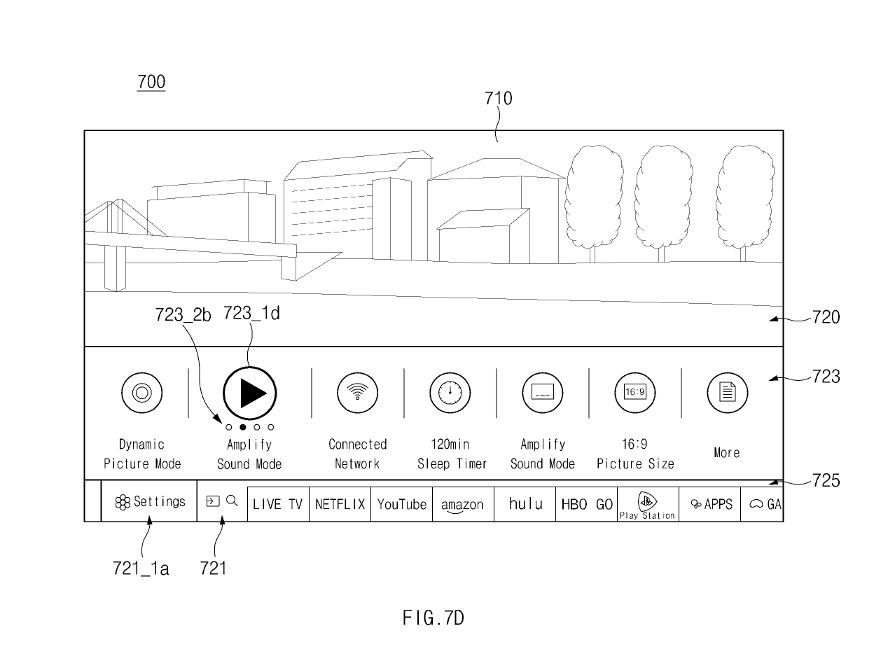

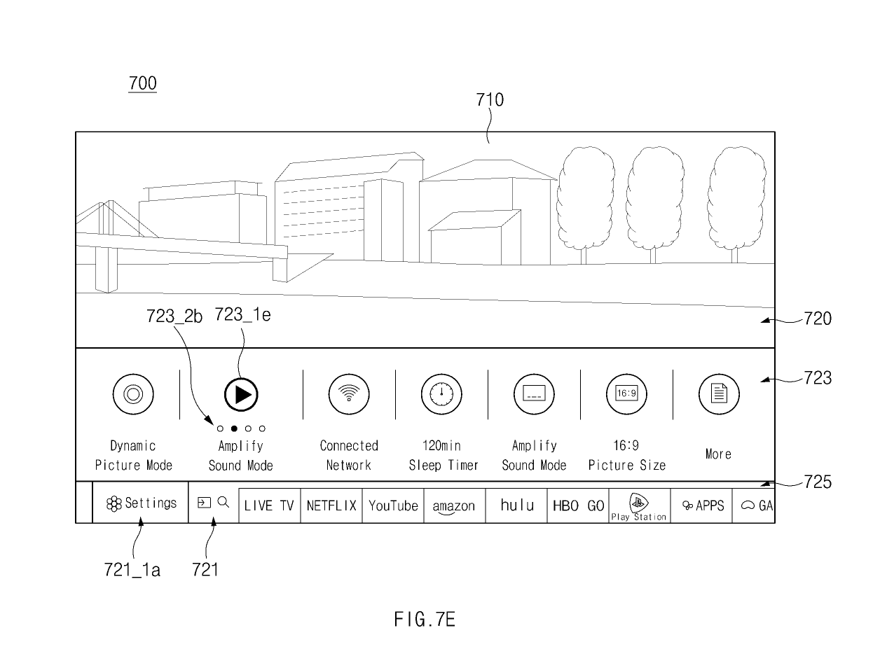

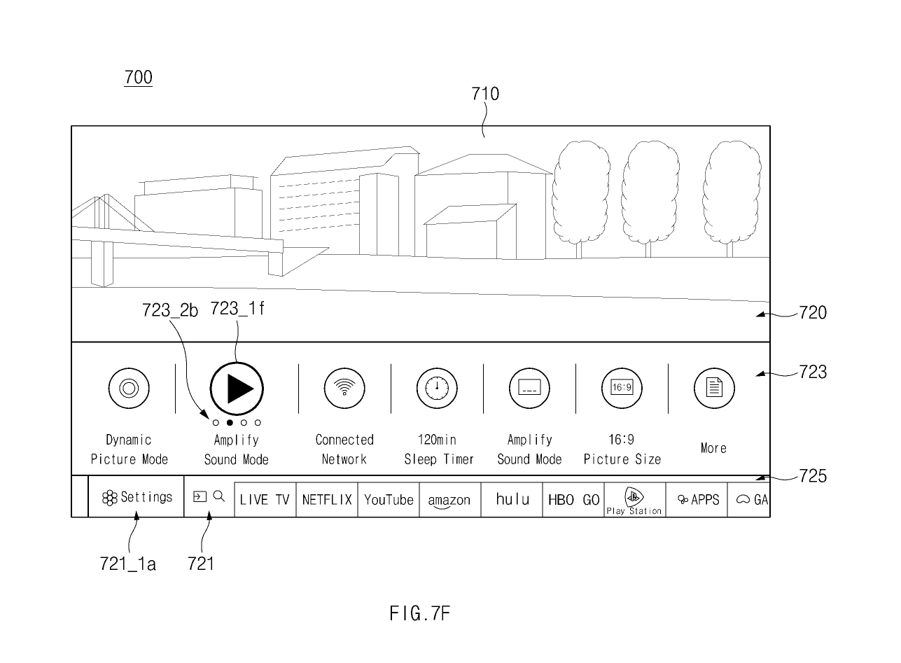

FIGS. 7A to 7F are views illustrating how an object is scaled when a sub object of a display apparatus according to an embodiment of the present disclosure is changed.

Referring to FIGS. 7A to 7F, the display apparatus 100 may display a content image 710 and a UI 720 in the display 130. In other words, a screen 700 displayed in the display 130 may include the content image 710 and the UI 720.

Referring to FIGS. 7A to 7C, if receiving a user input to select at least one of a plurality of objects, the display apparatus 100 may change the size of an object corresponding to the user input. For example, if receiving the user input, the display apparatus 100 may change the size of the object corresponding to the user input. For example, the display apparatus 100 may gradually reduce the size of the object corresponding to the user input from a first state 723_1a to a second state 723_1b and may gradually enlarge the size of the object corresponding to the user input from the second state 723_1b to a third state 723_1c. According to an embodiment, the display apparatus 100 may display an indicator 723_2a corresponding to a sub object of the selected object in the display 130.

Referring to FIGS. 7D to 7F, in a state where one object in the second menu 723 is selected, if receiving a user input to select one of a plurality of sub objects included in the selected object, the display apparatus 100 may change the object including the plurality of sub objects. For example, if receiving the user input, the display apparatus 100 may change the size of the object including the plurality of sub objects. According to an embodiment, the display apparatus 100 may display the indicator 723_2b corresponding to the selected sub object in the display 130.

According to an embodiment, the display apparatus 100 may scale the size of the object corresponding to the user input. For example, if receiving a user input to select one of a plurality of sub objects, the display apparatus 100 may change the size of the object in which the plurality of sub objects are included.

According to an embodiment, the display apparatus 100 may gradually reduce the size of the object including the plurality of sub objects during the first time period T1 from a fourth state 723_1d to a fifth state 723_1e. The display apparatus 100 may gradually enlarge the size of the object including the plurality of sub objects during the second time period T2 from the fifth state 723_1e to a sixth state 723_1f.

According to an embodiment, the display apparatus 100 may periodically change the size of the object corresponding to the user input by using the first time period T1 and the second time period T2 as one period. For example, the display apparatus 100 may periodically reduce and enlarge the object corresponding to the user input.

As such, the display apparatus 100 may change the size of an object including a plurality of sub objects, thus indicating that a selected object includes a plurality of sub objects selectable by the user.

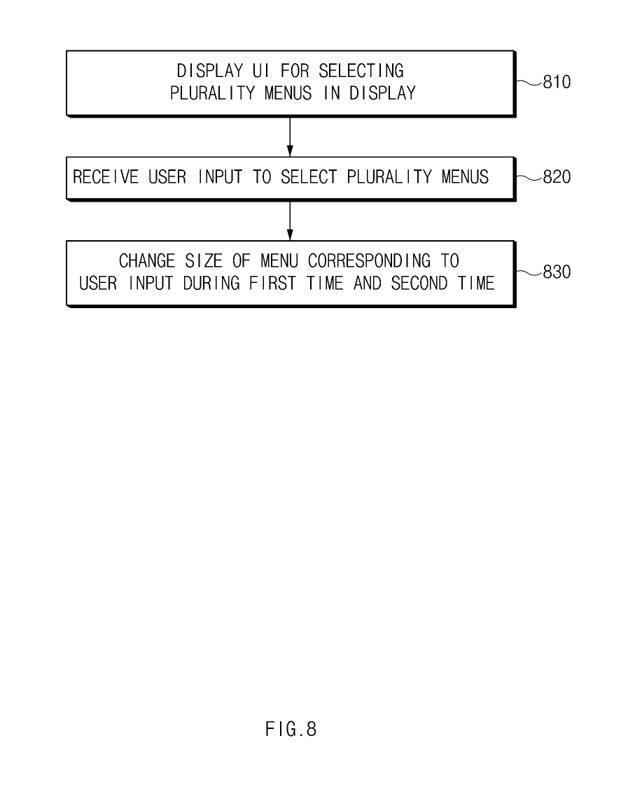

FIG. 8 is a flowchart illustrating a controlling method of a display apparatus, according to various embodiments of the present disclosure.

The flowchart illustrated in FIG. 8 may include operations processed in the above-described display apparatus 100 and may indicate a controlling method of the display apparatus 100 for changing the size of an object selected according to a user input. Although omitted below, the descriptions of the display apparatus 100 given with reference to FIGS. 1 to 7F may be applied to the flowchart illustrated in FIG. 8.

According to an embodiment, in operation 810, the display apparatus 100 may display a UI for selecting a plurality objects in the display 130. For example, the display 100 may display, in the UI, an object for selecting a content image to be displayed in the display 130. For another example, the display apparatus 100 may display, in the UI, an object including a plurality of sub objects capable of changing a setting state of the display apparatus 100.

According to an embodiment, in operation 820, the display apparatus 100 may receive a user input to select an object. For example, the display apparatus 100 may receive a user input for selecting a content image to be displayed in the display 130. For another example, the display apparatus 100 may receive a user input to select a plurality of sub objects capable of changing a setting state of the display apparatus 100.

According to an embodiment, in operation 830, the display apparatus 100 may change the size of the object corresponding to the user input during the first time period T1 and the second time period T2. For example, the display apparatus 100 may reduce the size of the object corresponding to the user input during the first time period T1 and may enlarge the size of the object corresponding to the user input during the second time period T2.

At least a part of an apparatus (e.g., modules or functions thereof) or a method (e.g., operations) according to various embodiments may be implemented by instructions stored in a computer-readable storage medium in the form of a program module. The instruction, when executed by a processor, may cause the processor to perform a function corresponding to the instruction. The computer-readable recording medium may include a hard disk, a floppy disk, a magnetic media (e.g., a magnetic tape), an optical medium (e.g., a compact disc read only memory (CD-ROM), a digital versatile disc (DVD), or a magneto-optical media (e.g., a floptical disk)), an embedded memory, or the like. The instruction may include a code created by a complier or a code executable by an interpreter.

Operations executed by modules, program modules, or other elements may be executed by a successive method, a parallel method, a repeated method, or a heuristic method. Alternatively, at least some of the operations may be executed in another order or may be omitted, or any other operation may be added. While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A display apparatus comprising:
a display;
an input module configured to receive a user input; and
a processor configured to:
display a user interface (UI) to provide a plurality of objects to be selected on the display;
receive the user input from the input module to select at least one of the plurality of objects from the UI displayed on the display; and
change a size of the selected at least one object corresponding to the user input
by enlarging the size of the selected at least one object corresponding to the user input during a first time and reduce the size of the selected at least one object corresponding to the user input during a second time, or
by reducing the size of the selected at least one object corresponding to the user input during the first time and enlarge the size of the selected at least one object corresponding to the user input during the second time.

2. The display apparatus of claim 1, wherein the processor is configured to:
change the size of the selected at least one object corresponding to the user input when the processor determines that a specific time elapses after the user input is received.

3. The display apparatus of claim 1, wherein the first time is longer than the second time, or the first time is shorter than the second time.

4. The display apparatus of claim 1, wherein the processor is configured to:
change a speed at which the size of the selected at least one object corresponding to the user input is changed; and
change the size of the selected at least one object corresponding to the user input depending on the changed speed.

5. The display apparatus of claim 4, wherein the processor is configured to:
increase and decrease the speed at which the size of the selected at least one object is changed, during the first time; and
increase and decrease the speed at which the size of the selected at least one object is changed, during the second time.

6. The display apparatus of claim 5, wherein the processor is configured to:
allow, during the first time, a first rate at which, in a period where a first speed at which the size of the selected at least one object is changed increases, the first speed increases per unit time to be smaller than a second rate at which, in a period where a second speed at which the size of the selected at least one object is changed decreases, the second speed decreases per unit time; and
allow, during the second time, a third rate at which, in a period where a third speed at which the size of the selected at least one object is changed increases, the third speed increases per unit time to be greater than a fourth rate at which, in a period where a fourth speed at which the size of the selected at least one object is changed decreases, the fourth speed decreases per unit time.

7. The display apparatus of claim 1, wherein the processor is configured to
when the user input is received, enlarge the size of the selected at least one object corresponding to the user input and then change the size of the enlarged object.

8. The display apparatus of claim 1, wherein the selected at least one object corresponding to the user input includes a plurality of sub objects, and
wherein the processor is configured to:
when a user input to select at least one sub object of the plurality of sub objects is received, change the size of the selected at least one object including the plurality of sub objects.

9. The display apparatus of claim 8, wherein the processor is configured to
when receiving a user input to select the sub object, display an indicator corresponding to the selected sub object on the display.

10. The display apparatus of claim 1, wherein the processor is configured to
change at least one of transparency, a display period, and a color of the selected at least one object corresponding to the user input during the first time and the second time.

11. A controlling method of an electronic apparatus, the method comprising:
displaying a UI which provides a plurality of objects to be selected on a display;
receiving a user input to select at least one of the plurality of objects; and
changing a size of the selected at least one object corresponding to the user input,
wherein the changing of the size of the selected at least one object includes:
enlarging the size of the selected at least one object corresponding to the user input during a first time and reducing the size of the selected at least one object corresponding to the user input during a second time, or
reducing the size of the selected at least one object corresponding to the user input during the first time and enlarging the size of the selected at least one object corresponding to the user input during the second time.

12. The method of claim 11, wherein the changing of the size of the object includes:
changing the size of the selected at least one object corresponding to the user input when a specific time elapses after the user input is received.

13. The method of claim 11, wherein the first time is longer than the second time, or the first time is shorter than the second time.

14. The method of claim 11, wherein the changing of the size of the selected at least one object further includes:
changing a speed at which the size of the selected at least one object corresponding to the user input is changed; and
changing the size of the selected at least one object corresponding to the user input depending on the changed speed.

15. The method of claim 14, wherein the changing of the speed further includes:
increasing and decreasing the speed at which the size of the selected at least one object is changed, during the first time; and
increasing and decreasing the speed at which the size of the selected at least one object is changed, during the second time.

16. The method of claim 15, wherein the increasing and decreasing of the speed at which the size of the selected at least one object is changed, during the first time includes:
increasing and decreasing the speed at which the size of the selected at least one object is changed, to allow a first rate at which, in a period where a speed at which the size of the selected at least one object is changed increases, the speed increases per unit time to be greater than a second rate at which, in a period where a speed at which the size of the selected at least one object is changed decreases, the speed decreases per unit time, and
wherein the increasing and decreasing of the speed at which the size of the selected at least one object is changed, during the second time includes:
increasing and decreasing the speed at which the size of the selected at least one object is changed, to allow a third rate at which, in a period where a speed at which the size of the selected at least one object is changed increases, the speed increases per unit time to be greater than a fourth rate at which, in a period where a speed at which the size of the selected at least one object is changed decreases, the speed decreases per unit time.

17. The method of claim 11, further comprising:
enlarging the size of the selected at least one object corresponding to the user input when the user input is received,
wherein the changing of the size of the selected at least one object includes:
changing the size of the enlarged object.

18. The method of claim 11, wherein the selected at least one object corresponding to the user input includes a plurality of sub objects,
further comprising:
receiving a user input to select at least one of the plurality of objects; and
changing the size of the selected at least one object including the plurality of sub objects.

19. The method of claim 18, further comprising:
displaying an indicator corresponding to a sub object corresponding to the user input in the display.

20. The method of claim 11, wherein the changing of the size of the selected at least one object includes:
changing the size of the selected at least one object while changing at least one of transparency, a display period, and a color of the selected at least one object corresponding to the user input during the first time and the second time.
